(19) United States
(12) Patent Application Publication
(10) Pub. No.: US 2004/0190295 A1
(43) Pub. Date: Sep. 30, 2004

(54) Reflector and reflector lamp

(75) Inventors: Wolfgang Andorfer, Munchen (DE); Axel Bunk, Munchen (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCH GLUHLAMPEN MBH, MUNCHEN (DE)

(21) Appl. No.: 10/758,393

(22) Filed: Jan. 16, 2004

(30) Foreign Application Priority Data
Jan. 24, 2003 (DE) 10302930.3

(51) Int. Cl. F21V 7/00

(52) U.S. Cl. 362/347; 362/341

(57) ABSTRACT

The invention relates to a shell-like reflector whose light-reflecting inner side is shaped in such a way that the reflector has two focal lines. In addition, the invention relates to a reflector lamp with such a reflector and an incandescent lamp, whose incandescent filament has at least two filament sections arranged in the focal lines.

### Technical Field

The invention relates to a reflector for an incandescent lamp, which is shell-like, has a light-reflecting inner side, a bottom region and a light exit opening, an aperture for an incandescent lamp being arranged in the bottom region. In addition, the invention relates to a reflector lamp having a reflector and an incandescent lamp arranged therein, the incandescent lamp having an incandescent filament with at least two filament sections which are arranged parallel to each other and are used to emit light, the reflector being shell-like, having a light-reflecting inner side, a bottom region and a light exit opening, an aperture for the incandescent lamp being arranged in the bottom region.

### BACKGROUND ART

A reflector of this type and a reflector lamp of this type are disclosed, for example, in European laid-open specification EP 0 446 461. This specification describes a reflector lamp having a parabolic reflector and an incandescent halogen lamp arranged therein, which has an incandescent filament aligned axially in the longitudinal axis of the lamp vessel, the longitudinal axis of the lamp vessel being identical with the optical axis of the reflector. As a result, the incandescent filament is arranged in the optical axis of the reflector, so that light beams which leave the reflector are aligned substantially parallel and focusing of the light in a preferred emission direction is made possible.

### DISCLOSURE OF THE INVENTION

It is a object of the invention to provide a reflector whose imaging properties are matched to an incandescent lamp, in particular one operated on mains voltage without ballast, and which has two filament sections arranged beside each other and used to emit light.

According to the invention, this object is achieved by a reflector for an incandescent lamp, which is shell-like, has a light-reflecting inner side, a bottom region and a light exit opening, an aperture for an incandescent lamp being arranged in the bottom region, characterized in that the light-reflecting inner side is curved in such a way that the reflector has two focal lines. Particularly advantageous refinements of the invention are described in the dependent patent claims.

The reflector according to the invention is shell-like and has a light-reflecting inner side, a bottom region, a light exit opening and an aperture arranged in the bottom region to accommodate an incandescent lamp, the light-reflecting inner side according to the invention being curved in such a way that the reflector has two focal lines. This configuration of the reflector makes it possible to insert the incandescent lamp into the reflector in such a way that its two filament sections arranged beside each other and used to emit light are in each case arranged in a focal line of the reflector. As a result, the light from both filament sections is focused by the reflector and deflected in the desired emission direction.

The two focal lines are advantageously arranged in a common plane and preferably run parallel or conically toward each other. As a result, the reflector is most suitable for lamps which have a U-shaped or V-shaped incandescent filament with at least two light-emitting filament sections arranged on different U or V limbs of the incandescent filament.

It has proven to be particularly advantageous to shape the reflector in such a way that the light-reflecting inner side has an elliptical contour in an arbitrary cross-sectional plane running through the reflector at right angles to the focal lines, the two focal points of the elliptical contour in each case being arranged at the point of intersection of one of the focal lines with the cross-sectional plane. In addition, the reflector is preferably shaped in such a way that the light-reflecting inner side has a parabolic contour in the cross-sectional plane running parallel with the focal lines and containing the minor semi-axes of the elliptical contours. As a result of this shaping, good focusing of the light emitted by both filament sections is achieved.

In order to be able to use the reflector according to the invention in rotationally symmetrical lights as well, the outer edge of the light exit opening is advantageously circular and only the inner edge of the light exit opening is elliptical. Accordingly, the wall thickness of the reflector varies along the light exit opening. The reflector according to the invention advantageously consists of a plastic, preferably of polyphenyl sulfide. As a result, it can be produced as an injection molding and has a low weight.

The reflector lamp according to the invention has a reflector with an incandescent lamp mounted therein, the one incandescent filament having at least two filament sections used to emit light. The reflector is shell-like, has a light-reflecting inner side, a light exit opening and a bottom region with an aperture arranged therein for the incandescent lamp. According to the invention, the light-reflecting inner side of the reflector is shaped in such a way that the reflector has two focal lines, and the incandescent lamp is aligned in the reflector in such a way that the at least two filament sections are in each case arranged along one of the two focal lines. As a result, the light from both filament sections is focused by the reflector and deflected in the desired emission direction.

The reflector lamp according to the invention preferably has an incandescent filament with two limbs which are connected and run substantially parallel to each other, are in each case arranged in one of the focal lines of the reflector and in each case have at least one filament section used to emit light.

### BRIEF DESCRIPTION OF THE DRAWINGS

In the following text, the invention will be explained in more detail using a preferred exemplary embodiment.

FIG. 1 shows a plan view of the light exit opening of the reflector according to the preferred exemplary embodiment

FIG. 2 shows a first side view of the reflector depicted in FIG. 1

FIG. 3 shows a second side view of the reflector depicted in FIG. 1 in a view rotated through 90 degrees as compared with FIG. 2

FIG. 4 shows a schematic side view of a reflector lamp according to the preferred exemplary embodiment.

### BEST MODE FOR CARRYING OUT THE INVENTION

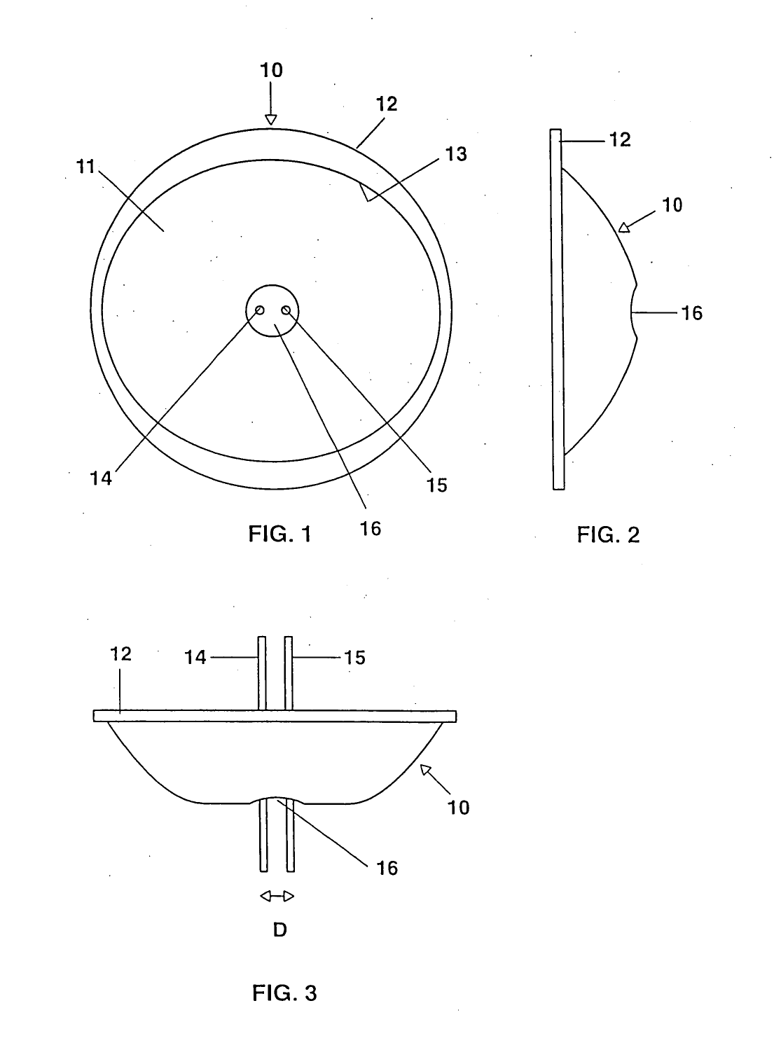

The reflector depicted in FIGS. 1 to 3 is a shell-like reflector 10 made of plastic, which is preferably produced in the injection molding process. The reflector 10 has a light exit opening whose outer edge 12 is circular and whose inner edge 13 is elliptical. The inner side, that is to say the inner surface of the reflector 10, is provided with a light-reflecting aluminum layer 11. The shell-like reflector 10 has a circular aperture for an incandescent halogen lamp in its bottom region located opposite the light exit opening. Apart from the outer edge 12 of the light exit opening, the reflector 10 has no rotational symmetry. In an arbitrary cross-sectional plane running parallel to the light exit opening, the inner side 11 of the reflector 10 has an elliptical contour. The further one moves away from the light exit opening in the direction of the bottom region, the greater the deviations from rotational symmetry become, that is to say the greater the eccentricity of the aforementioned elliptical cross sections. The two focal points of the aforementioned elliptical cross sections in each case lie on a straight line, which form the focal lines 14, 15 of the reflector 10. The distance D of the two focal lines 14, 15 from each other is 5 mm. The major semi-axis A of the aforementioned elliptical cross sections extends in the direction of the section connecting the two focal lines 14, 15, and the minor semi-axis B extends at right angles to this connecting section. In the table, values for the major and minor semi-axes A, B of the elliptical contour of the inner side 11 of the reflector are specified for thirteen cross-sectional planes arranged at different heights H at right angles to the focal lines 14, 15. In the side view of FIG. 2, that is to say in the plane which runs at right angles to the aforementioned cross-sectional planes and along the minor semi-axes B, the reflector 10 has a parabolic contour. Expressed in other words, the height H can be represented as a quadratic function of the minor semi-axis B. The height H=0 mm corresponds to the reflector base and H=26.2 mm corresponds to the light exit opening. The values belonging to the respective height value H for the semi-axes A, B of the elliptical contours of the inner side 11 are listed in the table.

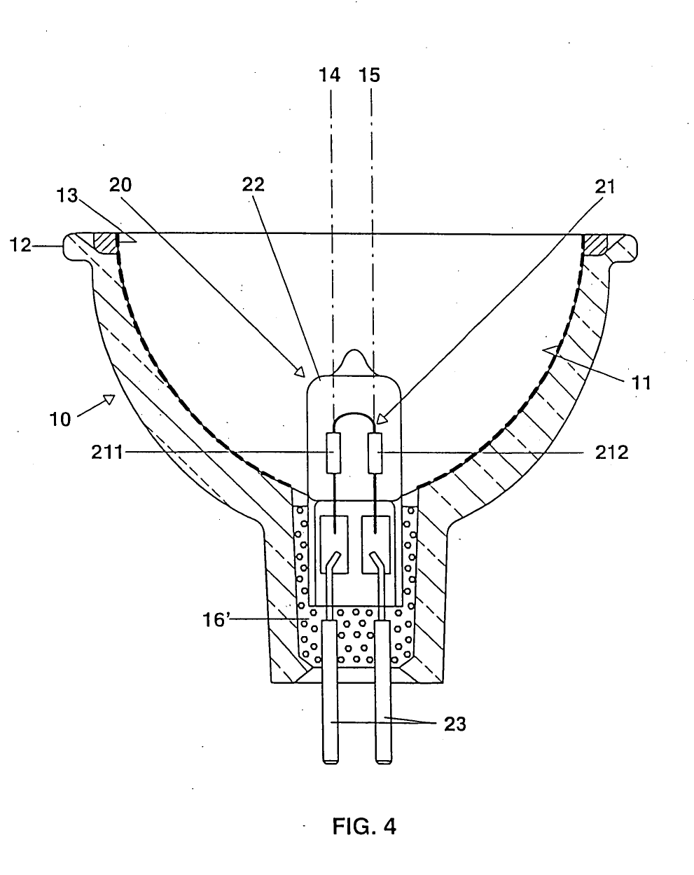

FIG. 4 depicts a reflector lamp in a highly schematic illustration. This reflector lamp has a reflector 10 and a high voltage incandescent halogen lamp 20 arranged therein. Apart from the shape of the aperture 16′, the reflector 10 has the same properties as the reflector depicted in FIGS. 1 to 2. For this reason, the same reference symbols have been used in FIGS. 1 to 4 for identical reflector parts. The incandescent halogen lamp 20 is provided for operation on mains voltage without the use of a ballast. In the glass lamp bulb 22 of the incandescent halogen lamp 20, an incandescent filament 21 is enclosed in a gastight manner and is supplied with electrical power by means of two power feed lines 23. The incandescent filament 21 is substantially U-shaped and has two filament sections 211, 212 which are arranged in parallel and used to emit light. Each U limb of the incandescent filament 21 is provided with a filament section 211, 212 used to emit light. The incandescent halogen lamp 20 is fixed in the aperture 16′ of the reflector 10 by means of cement in such a way that the filament sections 211, 212 are in each case arranged in one of the focal lines 14 and 15 of the reflector 10.

The invention is not restricted to the exemplary embodiments explained in more detail above. For example, the reflector lamp can be provided with different standardized bases, such as GU10, GZ10, G9, E14 or E27. In addition, the incandescent filament of the lamp can be configured in such a way that, for example, each U limb of the incandescent filament 21 has more than just one filament section used to emit light.

TABLE
Dimensions of the reflector depicted in FIGS. 1 to 4

| Height H [mm] | Major semi-axis A [mm] | Minor semi-axis B [mm] |
|---|---|---|
| 0 | 9.35 | 7.90 |
| 0.15 | 9.95 | 8.60 |
| 1.20 | 13.45 | 12.49 |
| 2.60 | 17.04 | 16.29 |
| 4.40 | 20.75 | 20.14 |
| 6.40 | 24.22 | 23.70 |
| 8.60 | 27.54 | 27.08 |
| 11.00 | 30.75 | 30.34 |
| 13.40 | 33.65 | 33.28 |
| 16.20 | 36.75 | 36.41 |
| 19.20 | 39.82 | 39.50 |
| 22.40 | 42.83 | 42.54 |
| 26.20 | 46.16 | 45.89 |

1. A reflector for an incandescent lamp, which is shell-like, has a light-reflecting inner side, a bottom region and a light exit opening, an aperture for an incandescent lamp being arranged in the bottom region, wherein said light-reflecting inner side is curved in such a way that the reflector has two focal lines.

2. The reflector as claimed in claim 1, wherein the two focal lines are arranged in a common plane.

3. The reflector as claimed in claim 1, wherein the inner edge of the light exit opening is elliptical.

4. The reflector as claimed in claim 2, wherein, in an arbitrary cross-sectional plane running through the reflector at right angles to the focal lines, the light-reflecting inner side of the reflector has an elliptical contour, the focal points of the elliptical contour being arranged at the point of intersection in each case of one of the focal lines with the cross-sectional plane.

5. The reflector as claimed in claim 4, wherein, in the cross-sectional plane through the reflector running parallel to the focal lines and containing the minor semi-axes of the elliptical contours, the light-reflecting inner side of the reflector has a parabolic contour.

6. The reflector as claimed in claim 1, wherein the outer edge of the light exit opening is circular.

7. The reflector as claimed in claim 1, wherein the reflector consists of a plastic.

8. A reflector lamp having a reflector and an incandescent lamp arranged therein,
the incandescent lamp having an incandescent filament with at least two filament sections which are arranged parallel to each other and are used to emit light,
the reflector being shell-like, having a light-reflecting inner side, a bottom region and a light exit opening, an aperture for the incandescent lamp being arranged in the bottom region, wherein
said light-reflecting inner side of the reflector is curved in such a way that the reflector has two focal lines,
said incandescent lamp is aligned in the reflector in such a way that the at least two filament sections are in each case arranged along one of the focal lines.

9. The reflector lamp as claimed in claim 8, wherein the two focal lines are arranged in a common plane.

10. The reflector lamp as claimed in claim 9, wherein, in an arbitrary cross-sectional plane through the reflector lamp running at right angles to the focal lines, the light-reflecting inner side of the reflector has an elliptical contour, the focal points of the elliptical contour being arranged at the point of intersection in each case of one of the focal lines with the cross-sectional plane.

11. The reflector lamp as claimed in claim 8, wherein the incandescent filament has two limbs that are connected to each other, at least one of the at least two filament sections being arranged on each of these limbs and each limb in each case being arranged in one of the focal lines of the reflector.

12. The reflector lamp as claimed in claim 10, wherein, in the cross-sectional plane through the reflector lamp running parallel to the focal lines and containing the minor semi-axes of the elliptical contours, the light-reflecting inner side of the reflector has a parabolic contour.

13. The reflector as claimed in claim 3, wherein, in an arbitrary cross-sectional plane running through the reflector at right angles to the focal lines, the light-reflecting inner side of the reflector has an elliptical contour, the focal points of the elliptical contour being arranged at the point of intersection in each case of one of the focal lines with the cross-sectional plane.

14. The reflector as claimed in claim 13, wherein, in the cross-sectional plane through the reflector running parallel to the focal lines and containing the minor semi-axes of the elliptical contours, the light-reflecting inner side of the reflector has a parabolic contour.
